(19) United States
(12) Patent Application Publication
(10) Pub. No.: US 2018/0141209 A1
(43) Pub. Date: May 24, 2018

(54) DETACHABLE AND ATTACHABLE MODULAR GRIPPER FOR UNIVERSAL USE

(71) Applicant: Daegu Gyeongbuk Institute of Science and Technology, Daegu (KR)

(72) Inventors: Sang Mun LEE, Daegu (KR); Jinung AN, Daegu (KR); Boo Hwan LEE, Daegu (KR); Dae Han HONG, Daegu (KR)

(73) Assignee: Daegu Gyeongbuk Institute of Science and Technology, Daegu (KR)

(21) Appl. No.: 15/370,159

(22) Filed: Dec. 6, 2016

(30) Foreign Application Priority Data
Nov. 22, 2016 (KR) 10-2016-0155574

(51) Int. Cl. B25J 9/08; B25J 15/06; B25J 19/00; B25J 19/02

(52) U.S. Cl. CPC B25J 9/08; B25J 19/023; B25J 19/0054; B25J 15/0616

(57) ABSTRACT

The present invention relates to an electric gripper driven by a motor, and more particularly to a detachable and detachable modular gripper for universal use enhanced in universality and increased in easiness of maintenance and repair by forming a gripper in a plurality of modules. the gripper including a housing mounted with a gripping unit for gripping a work, and a front module attachable and detachable to the housing as a separate part, wherein the front module includes at least one of a robot server interface inputting a first signal to or outputting the first signal from an external device,

a driving module controller inputting a second signal or an electric power to, or outputting the second signal or the electric power from a driving module, and a sensor interface part inputting or outputting a third signal of a sensor detecting an operation state of the gripping unit, and the gripper further including a gripping unit, a housing mounted with a gripping unit, wherein the gripping unit includes a gripping module gripping the work, and a driving module providing a driving force to the gripping module, and one of the gripping module and the driving module is attachably and detachably provided on the housing.

### TECHNICAL FIELD

The present invention relates to an electric gripper driven by a motor, and more particularly to a detachable and detachable modular gripper for universal use enhanced in universality and increased in easiness of maintenance and repair by forming a gripper in a plurality of modules.

### BACKGROUND ART

In general, a gripper is one of end-effectors mounted at a distal end of an industrial robot and used for gripping a work (work product) with fingers or with an entire hand, or makes it easier to grip works. The gripper is operated by a pneumatic method using a pressure of fluid, and by an electric method using an electric motor.

The Korean Registered Patent Publication NO.: 10-0188859 discloses a gripper operated by a VCM (Voice Coil Motor).

### CITED REFERENCE DOCUMENT

### Patent Document

Korean Registered Patent Publication NO.: 10-0188859

### DISCLOSURE OF INVENTION

### Technical Subject

The present invention relates to an electric gripper operated by an electric motor, and more particularly to a detachable and detachable modular gripper for universal use enhanced in universality and increased in easiness of maintenance and repair by forming a gripper in a plurality of modules.

Technical problems to be solved by the present invention are not restricted to the abovementioned, and any other technical problems not mentioned so far will be clearly appreciated from the following description by skill in the art.

### Technical Solution

An object of the present invention is to solve at least one or more of the above problems and/or disadvantages in whole or in part and to provide at least the advantages described hereinafter.

In order to achieve at least the above objects, in whole or in part, and in accordance with the purposes of the present invention, as embodied and broadly described, and in one general aspect of the present invention, there is provided a detachable and detachable modular gripper for universal use, the gripper comprising:

a housing mounted with a gripping unit for gripping a work (work product); and

a front module attachable and detachable to the housing as a separate part, wherein the front module includes at least one of a robot server interface inputting a first signal to or outputting the first signal from an external device,

a driving module controller inputting a second signal or an electric power to, or outputting the second signal or the electric power from a driving module, and

a sensor interface part inputting or outputting a third signal of a sensor detecting an operation state of the gripping unit.

In another general aspect of the present invention, there is provided a detachable and detachable modular gripper for universal use, the gripper comprising:

a gripping unit;

a housing mounted with a gripping unit, wherein

a gripping unit includes a gripping module gripping a work, and a driving module providing a driving force to the gripping module, and one of the gripping module and the driving module is attachably and detachably provided on the housing.

### Advantageous Effects

The detachable and detachable modular gripper for universal use according to the present invention can maximize adaptability of gripper function and performance to a subject operating environment by defining a lower configuration of gripper device for each module and configuring in compatibility for each module, unlike the conventional gripper fixed in specification such as function and performance. Thus, the gripper according to the instant invention can maximize an operation coordinating capability by adequately changing in response to the environment. That is, the detachable and detachable modular gripper for universal use enhanced in universality according to the present invention can be configured in plural number to enhance the universality and to provide ease in repair and maintenance.

An electric coupling between a front module and a gripping unit in the detachable and detachable modular gripper for universal use according to the present invention may be realized through an electrical conductivity by allowing a spring fin to contact a conductive plate. The tight connection by the elastic force of the spring fin can prevent an improper contact caused by trembling, shock and tolerance of the device.

### BRIEF DESCRIPTION OF DRAWINGS

FIG. 1 is a block diagram illustrating a detachable and detachable modular gripper for universal use according to the present invention.

FIG. 2 is an exploded view illustrating a detachable and detachable modular gripper for universal use according to an exemplary embodiment of the present invention.

FIG. 3 is a perspective view illustrating a front module according to an exemplary embodiment of the present invention.

FIG. 4 is a conceptual view illustrating an attachable and detachable relationship between a front module and a gripping unit according to the present invention.

FIG. 5 is a conceptual view illustrating an attachable and detachable relationship between a driving module and a jaw module according to the present invention.

FIG. 6 is a perspective view illustrating a bridge according to the present invention.

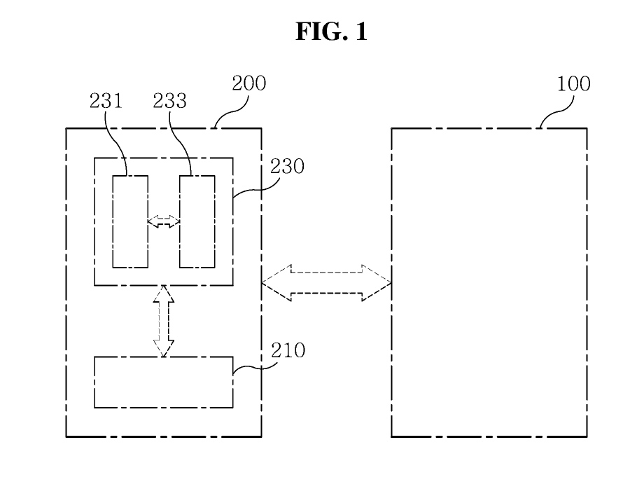

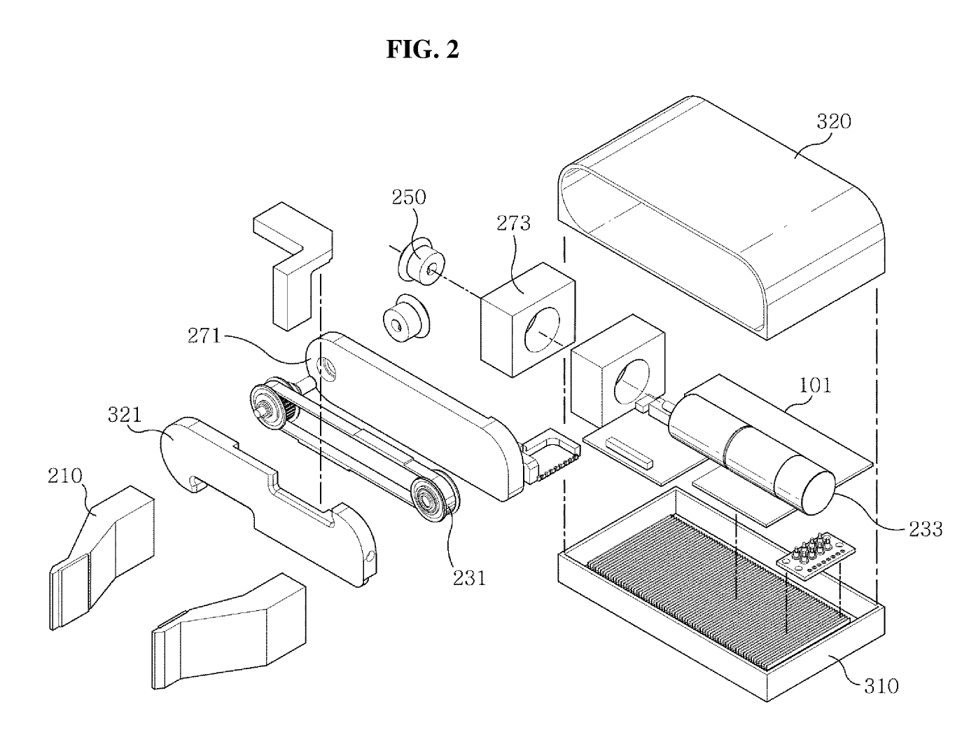

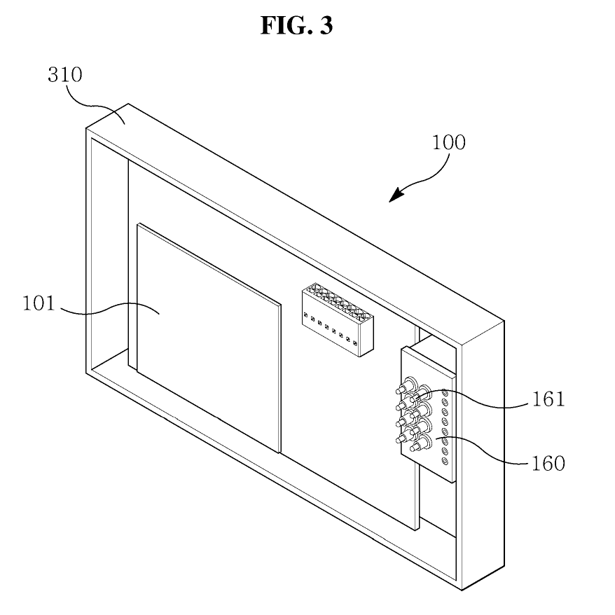

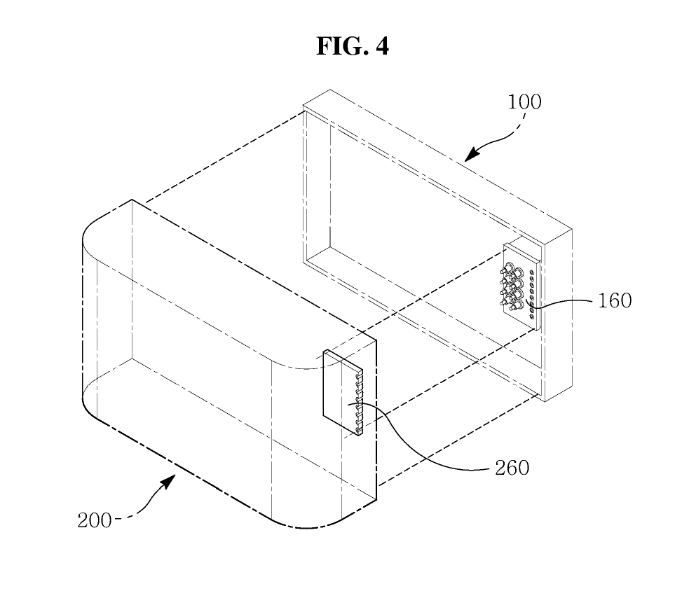

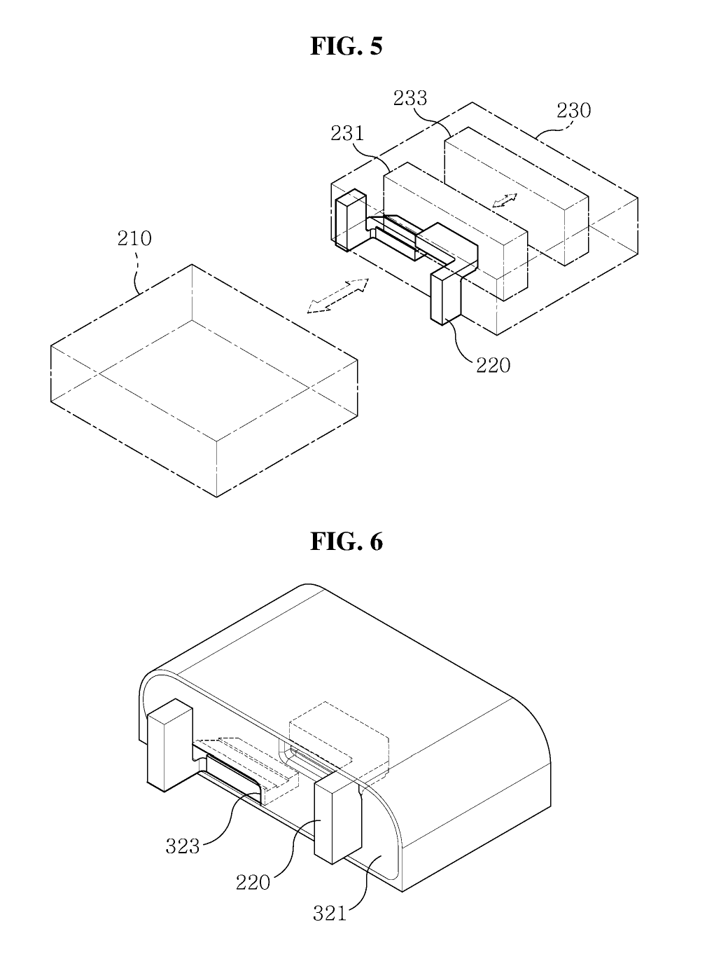

### BEST MODE

Now, the exemplary embodiments of the present disclosure will be described in detail with reference to the accompanying drawings.

In describing the present invention, detailed descriptions of constructions or processes known in the art may be omitted to avoid obscuring appreciation of the invention by a person of ordinary skill in the art with unnecessary detail regarding such known constructions and functions. Accordingly, in the drawings, the size and relative sizes of layers, regions and/or other elements may be exaggerated or reduced for clarity.

The meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

Furthermore, in describing the present invention, a work and a work product may be interchangeably used throughout the specification.

Hereinafter, the detachable and detachable modular gripper for universal use according to the present invention will be described with reference to the 1-6 accompanying drawings.

The detachable and detachable modular gripper for universal use according to the present invention may be mounted at a distal end of a robot arm to grip or absorb a work) so that the object can be fixed or moved by a robot.

The detachable and detachable modular gripper for universal use according to the present invention may maximize a gripper function and performance in response to operation environment by defining a lower configuration of the gripper device by each module and by being replaceable with each module, unlike the conventional gripper fixed in specifications in terms of function and performance.

Thus, the detachable and detachable modular gripper for universal use according to the present invention can maximize the operating coordination capability because of being adequately changeable in response to environment. That is, the detachable and detachable modular gripper for universal use according to the present invention can enhance the universality and easiness of maintenance and repair by forming the gripper with a plurality of modules.

The detachable and detachable modular gripper for universal use according to the present invention may include a gripping unit (200), and a front module (100) inputting and outputting control information of the gripping unit (200).

The detachable and detachable modular gripper for universal use according to the present invention may include a housing (320) surrounding the gripping unit (200), and a case (310) surrounding the front module (100). The case (310) or the housing (320) may be internally or externally provided with a cooling fin. The cooling fin may be provided on the case (310) or the housing (320) in a wrinkled metal plate. The cooling fin may be provided with a material of high thermal conductivity and with a maximized cross-section in the wrinkled shape. The cooling fin can enhance a heat circulation effect by broadening an inner or outer air contacting area.

The detachable and detachable modular gripper for universal use according to the present invention may include a housing (320) mounted with a gripping unit (200) gripping an object and a front module (100) attachable to and detachable from the housing (320) as a separate part. The front module (100) may be provided with a PCB (Printed Circuit Board) to process an electrical signal. The coupling and separation between the front module (100) and the gripping unit (200) may mean a mechanical coupling and separation, and an electrical coupling and separation as well.

The gripping unit (200) may include a jaw module (210) gripping a work, and a driving module (230) providing a driving force to the jaw module (210). The front module (100) may include at least one of a robot server interface part inputting a first signal from and outputting the first signal to a robot server, a driving module (230) controller inputting a power or a second signal from and outputting the power or the second signal to the driving module (230), and a sensor interface part inputting and outputting a third signal of a sensor detecting an operation state of the jaw module (210).

The front module (100) may be connected to an external device via communication, and input and output a first signal via the communication. The external device connected to the front module (100) via communication may be robot server controlling an entire robot. The first signal may mean all electrical, electronic or communication signals transmitted to or received from between the external device and the detachable and detachable modular gripper for universal use according to the present invention. The robot server interface part provided at the front module (100) may manage input and output of the first signal meaning all the electrical, electronic or communication signals transmitted to or received from between the external device and the detachable and detachable modular gripper for universal use according to the present invention.

The gripper control information may be transmitted from the external device to the front module (100) as a first signal through wired or wireless communication. The first signal may be at least one of communication specifications among Ethernet, Ethercat, RS485/422, RS232 and CAN, and may be changeable by the robot server interface part in response to the kinds of external devices. A digital IO or an analogue IO to be inputted to the driving module (230) controller may be generated by changing the first signal transmitted from the external device in response to any one of the communication specifications.

When the detachable and detachable modular gripper for universal use according to the present invention is applied to an industrial site, the robot arm mounted with the gripper device may be inconsistent. That is, the external device controlling the robot arm may exist in various types depending on manufacturers and models. Thus, the types of communication specifications transmitted to the gripper device may be also changeable depending on the types of external devices.

In an exemplary embodiment, the front module (100) may be provided with a robot server interface part applicable with a plurality of communication specifications including at least one of Ethernet, Ethercat, RS485/422, RS232 and CAN as a first signal. At this time, the robot server interface part may recognize the communication specification of the external device when communication is connected with the external device, and may input the first signal from and output the first signal to the external device by selecting the communication specification same as the recognized communication specification.

In another exemplary embodiment, the front module (100) may be provided with a plurality of types including a robot server interface part set in one of mutually different communication specifications among the Ethernet, Ethercat, RS485/422, RS232 and CAN.

The detachable and detachable modular gripper for universal use according to the present invention may be attached to or detached from the gripping unit (200) by selecting a type of front module (100) of communication method same as the communication specification as the external device.

That is, the front module (100) may include a first front module (100) and a second front module (100), and one of the first front module (100) and the second front module (100) may be selectively attached to or detached from the gripping unit (200) depending on signal pattern of first signal, second signal and third signal.

The front module (100) according to the present invention may include a driving module (230) controller mounted with a digital IO card or an analogue IO card generating a second signal inputted from or outputted to the gripping unit (200) by changing the first signal transmitted from the external device.

The second signal may be a signal inputted and outputted between the driving module (230) and the front module (100) and related to a control command of the driving module (230). The digital IO may input and output a digital signal by being allocated to a Bit data. The analogue IO input and output an analogue signal in voltage or current.

A signal outputted from a motor or an encoder of the driving module (230) may be one of an analogue signal or a digital signal depending on the type of the driving module (230). The type of front module (100) including the digital TO or an analogue TO may be attached to or detached from the gripping unit (200) depending on the type of signal inputted in and outputted from the driving module (230). Alternatively, the front module (100) may include both the digital TO card and the analogue TO card and a relevant card may be applied depending on the type of inputted signal.

The third signal may be a signal measured by a sensor included in the gripping unit (200). The gripping unit (200) may include at least one or more of a camera sensor, a force sensor, a tactile sensor, and a speed sensor.

The third signal which is a sensor measurement signal may be directly inputted to the front module (100) as an analogue signal of measurement value, or may be inputted to the front module (100) by changing a measurement value to a digital signal by a PCB disposed with a sensor and a set. Furthermore, the types of sensor measurement values included by a third signal among a camera sensor, a force sensor, a position sensor, a tactile sensor and speed sensor measurement value may be changed depending on the types of sensor included by each type of gripping unit (200).

That is, the types and methods of signals outputted in response to the types of gripping unit (200) may be changed. For example, one of the types in the gripping unit (200) can output a position sensor value and a tactile sensor value in an analogue signal, and another type can output a camera sensor value and a force sensor value in a digital signal.

As discussed here, the types and methods of sensor signals to be processed by the front module (100) may be changed depending on the type of the gripping unit (200). Thus, the sensor interface part of the front module (100) may be disposed with an AD/DA converter, unify a signal pattern in a digital signal or an analogue signal by receiving a third signal, and process in conformity with the types of measurement values by recognizing the sensor types that have sent the measurement values.

That is, the sensor interface part of the front module (100) can input a digital signal from and output the digital signal to an external device by mounting an AD/DA converter. Furthermore, the front module (100) can include a DAQ (Data Acquisition) card and store a sensor data of collected third signals. The front module (100) can make an electric contact with the gripping unit (200), where the electric contact can be realized by a face-to-face contact between a first electric contact part provided at a partial area of a lateral surface of the case (310) and a second electric contact part provided at a partial area of a lateral surface of the housing (320).

Each of the first electric contact part and the second electric contact part may take a plate shape. One of the first electric contact part and the second electric contact part may be provided with a plurality of spring fins (161) capable of being changeable in length to a direction perpendicular to a plate plane surface, and the other electric contact part may be provided with a plurality of conductive plates at a position opposite to each spring fin (161). The conductive plate may be a metal plate electrically conductible with the spring fin (161) and may be contacted on a one-on-one matched base with the spring fin (161).

The electric coupling between the front module (100) and the gripping unit (200) in the detachable and detachable modular gripper for universal use according to the present invention may be realized by an electric conductivity through contact between the spring fin (161) and the conductive plate.

The spring fin (161) is made of a conductive metal material and can be expanded by receiving an elastic force to a lengthwise direction. Contact between a distal end of the spring fin (161) and the conductive plate can be further facilitated by the spring fin (161) receiving the elastic force lengthened to a lengthwise direction. The close contact by the elastic force of the spring fin (161) can prevent the defective contact caused by shaking of the device, shock and tolerance.

The front module (100) may be provided in a plural type, and each type may be changed according to signal pattern of first signal, second signal and third signal, and types of processing data. The signal pattern may be changed in response to the communication types of Ethernet, Ethercat, RS485/422, RS232 and CAN, or may be changed according to whether the type is analogue or digital. The process data may be changed depending on a motor command and a sensor measurement value.

The gripping unit (200) according to the present invention may include a jaw module (210) gripping a work, and a driving module (230) providing a driving force to the jaw module (210). The driving module (230) may include a motor part (233) providing a mechanical power of turning effect (torque) using an electricity, and a power transmission part (231), where the power transmission part (231) converts the turning effect of the motor part (233) to a driving force and transmits the driving force to the jaw module (210). The motor part (233) may include a motor generating a rotation power, a motor control means issuing a control command to the motor, and an encoder measuring a rotation of the motor or a rotation speed.

The motor part (233) may be modularized by configuring the motor, the motor control means and the encoder in one pack. The motor part (233) may be formed in a cylindrical shape, and may be coupled in the order of the motor, the motor control means, the encoder, or in the order of the motor, the motor control means to the lengthwise direction. The motor part (233) may be attached or detached by being inserted into a first bracket (273) provided inside of the housing (320). The first bracket (273) may be closely fixed inside the housing (320), and may include an insertion hole having a cross-sectional shape of the motor part (233), where the motor part (233) may be attached or detached to the housing (320) by being inserted into the insertion hole.

The power transmission part (231) may transmit the power of the motor part (233) to the jaw module (210). The power transmission part (231) may convert the turning effect of the motor to a motion corresponding to a driving method of the jaw module (210) and transmit the motion to the jaw module (210). The power transmission part (231) may include any one gear from a rack and pinion, a worm gear, a timing belt, and a timing gear depending on a driving method of the jaw module (210).

The power transmission part (231) may include a main shaft, and may receive a power of the motor part (233) from the main shaft, and may transmit the power to a gear provided on any one of the rack and pinion, the worm gear, the timing belt, and the timing gear. The gear of the power transmission part (231) may be attached to or detached from a second bracket (271) provided at the inside of the housing (320). The second bracket (271) may be closely coupled to the inside of the housing (320) to fix the power transmission part (231) to the inside of the housing (320).

The driving module (230) may be provided with a cross part (250) in which a rotation shaft of the motor part (233) and the main shaft of the power transmission part (231) are connected. The cross part (250) may transmit the turning effect received from the rotation shaft to the main shaft. The cross part (250) may be a gear including a spur gear, an internal gear and a spline and boss, when an axis direction of the rotation shaft and an axis direction of the main shaft are parallel. The cross part (250) may be a bevel gear when an axis direction of the rotation shaft and an axis direction of the main shaft are vertical.

When the motor part (233) is separated from the driving module (230), the power transmission part (231) is separated from the driving module (230), a connection state between the rotation shaft of the motor part (233) and the main shaft of the power transmission part (231) may be released through the cross part.

The driving module (230) may be provided in a plural type, and the type may be changed depending on the specification of the motor and the kinds of the gears. The jaw module (210) may grip a work (object) using a mechanical driving. The jaw module (210) may include a jaw means directly contacting the work which is an object of gripping. The jaw module (210) may be coupled to the driving module (230) to contact the work using the driving force transmitted from the driving module (230). The jaw module (210) may perform a linear or rotating motion using a driving force from the driving module (230). The jaw module (210) may be provided with a plurality of jaw means, and a relative distance between the jaw means may be adjusted by the driving module (230) to grip the work. That is, when an object exists between the jaw means, the object can be gripped as the jaw means mutually get closed or neared together.

The jaw module (210) may fix the work to the jaw module (210) using an attaching means provided at the jaw module (210). The attaching means may be attached or absorbed to the work when being contacted to the work to attachably fix the jaw module (210) and the work.

In an exemplary embodiment, the attaching means may be attached to the work by being coated with an adhesive. In another exemplary embodiment, the attaching means may be provided with a suction device, where the jaw module (210) and the object may be attachably fixed by generation of negative pressure to the suction device. That is, the attaching means may be a suction device forming a chemical adhesive or a negative pressure.

The jaw module (210) may include a force sensor, a tactile sensor and a camera sensor. The jaw module (210) may convert a value measured by the sensor to an analogue signal and directly transmit the analogue signal to the front module (100). Alternatively, the jaw module (210) may be mounted at a PCB separate from the front module (100). The jaw module (210) mounted on the PCB may convert the measurement signal of the sensor to a digital signal and transmit the digital signal to the front module (100). The jaw module (210) may be provided in a mutually independent pair of parts and may be attached to or detached from a bridge (220) member connected to the driving module (230).

One side of the bridge (220) member may be connected to the driving module (230) provided at an inside of the housing (320), and the other side of the bridge (220) member may be attached to or detached from the jaw module (210), and an intermediate section between the one side and the other side of the bridge (220) member may be movably inserted into a slot (323) provided at the housing (320).

In a more detailed exemplary embodiment, the driving module (230) may include a main shaft receiving a driving force from the motor part (233) accommodated inside the housing (320), a driven shaft opposite to the main shaft, and a timing belt connecting the main shaft and the driven shaft. The linear movement of the timing belt may be transmitted to the bridge (220) member, where one side of the bridge (220) member may be connected to the timing belt and the other side of the bridge (220) member may be attached to or detached from the jaw module (210). An intermediate section between the one side and the other side of the bridge (220) member may be inserted into a slot (323) provided at the housing (320). The slot (323) may be formed at a surface (321) of the housing (320) opposite to the object.

The driving module (230) may be reduced in gear life, because of foreign object like the dust being inserted into the gear when the gear devices are exposed to outside as the driving module (230) includes the gear devices. Thus, the driving module (230) needs to be protected from the outside dust by being encompassed by the housing (320). In this case, when the jaw module (210) is directly attached to or detached from the driving module (230) at an inside of the housing (320), the coupling and separation may be obstructed due to the housing (320) standing in the way (being obstructive).

Hence, the detachable and detachable modular gripper for universal use according to the present invention can make it easy to attach and detach the jaw module (210) and can completely protect the driving module (230) against the outside dust, because a connection part is used for bridge (220) member for coupling between the jaw module (210) and the driving module (230), and an intermediate section of the bridge (220) member strides over the slot (323) provided at the housing (320).

The jaw module (210) may be provided in a plural type, and the type may be changed in response to the shape and size of the jaw means, and fixing method of object. The grip (grasp) of a work (object) by the detachable and detachable modular gripper for universal use according to the present invention may operate in the following fashion.

At the start of operation, at least one or more work (work product) information including the size, feel, shape, strength and mass of the work, which is an object of the grip, may be inputted. At least one or more operation information among a grip time, a grip frequency and grip strength of the work, along with the work information, may be inputted. The grip time may mean a time when the grip starts, and a time when the grip ends. The grip frequency may mean a repeated frequency of grip on the work. The grip strength may mean how hard or strong the work is fixed. The work information and operation information may be inputted to the front module (100) via a first signal by being inputted from the external device.

When the work information and operation information are inputted, a camera sensor mounted on the gripping unit (200) may detect a position of the work and the detachable and detachable modular gripper for universal use according to the present invention may approach the work by the robot arm. The camera sensor may be disposed at the jaw module (210) or the housing (320).

When the gripping device approaches the work in response to the measurement value of the camera sensor, the driving module (230) may provide a driving force to the jaw module (210) in response to a command of the second signal received from the front module (100). In order to prevent the driving force of the driving module (230) from causing any damage to the work, the driving force of the driving module (230) may be driven by receiving a feedback of the measurement value of force sensor mounted on the jaw module (210) or the driving module (230), the position sensor, the speed sensor and the encoder of the motor part (233). That is, the work can be gripped (grasped) with a gripping power appropriate enough not to cause a damage to the work by the jaw module (210) that grips (grasps) the work with a driving force provided by the feedback of the measurement value from the sensor.

For example, the work can be gripped by detecting a pressure applied to the work from the force sensor, and by the position sensor that detects a displacement between the work and the jaw module (210).

The detachable and detachable modular gripper for universal use according to the present invention may be disposed with the front module (100) of plural type, the driving module (230) and the jaw module (210), and each type may be grouped in response to the size, mass, strength and shape of the work.

In an exemplary embodiment, an intrinsic code may be provided according to the size, mass, strength and type of shape of the work. The front module (100), the driving module (230) and the jaw module (210) may be assembled by being selected of type corresponding to an intrinsic code of the work.

Size may be provided with a serial number n (n is an intrinsic character (proper) string), mass may be provided with a serial number m (m is an intrinsic character string), strength may be provided with a serial number l (l is an intrinsic character string), shape may be provided with a serial number r (r is an intrinsic character string), and each work may be provided with a code of “work-nmlr”.

For example, when 1˜10 cm is “a” in assignment of proper string to size, 10˜100 cm is “b” and 100˜1000 cm is “C”, and 0.1˜1 kg is “a” in assignment of proper string to mass, 1˜10 kg is “b” and 10˜100 kg is “c”, 1˜10 mpa is “a” in assignment of proper string to strength, 10˜100 mpa is “b”, and 100˜1000 mpa is “C”, a rectangle of a shape is “a”, a cylinder of a shape is “b”, and a cube of a shape is “c”, a cylindrical shape of a work product having a size of 15 cm, a mass of 7 kg and strength of 6 mpa may be provided with a code of “work product-bbab”. A user may use a front module (100), a driving module (230) and a jaw module (210) of a type corresponding to the “work product-bbab”.

The front module (100), the driving module (230) and the jaw module (210) may be provided in a plural number depending on selection information, and as a result, the particular front module (100), the particular driving module (230) and the particular jaw module (210) selected by the selection information may be assembled. The selection information may include at least one of size, mass, strength and shape of the work product.

When an intrinsic code mutually distinguishable for each work product in response to the selection information, the front module (100), the driving module (230) and the jaw module (210) may be selected in response to the intrinsic code and may be mutually assembled.

The type of each module may be determined by specification of the device. That is, the front module (100) may be provided in a plural number, and each type may be changed or varied according to the signal pattern of first signal, second signal and third signal, and kinds of processing data. The driving module (230) may be provided in a plural type, and the type of driving module (230) may be changed or varied according to specification of motor and kinds of gears. The jaw module (210) may be provided in a plural type, and the type of jaw module (210) may be changed or varied according to the shape and size of the work product and fixing method of the work product.

Although the abovementioned embodiments according to the present invention have been described in detail with reference to the above specific examples, the embodiments are, however, intended to be illustrative only, and thereby do not limit the scope of protection of the present invention. Thereby, it should be appreciated by the skilled in the art that changes, modifications and amendments to the above examples may be made without deviating from the scope of protection of the invention.

[Description of Reference Numerals]

| | |
|---|---|
| 100: front module | 101: PCB |
| 160: first contact part | 161: spring fin |
| 200: gripping unit | 210: jaw module |
| 220: bridge | 230: driving module |
| 231: power transmission part | 233: motor part |
| 250: cross part | 260: second contact part |
| 271: second bracket | 273: first bracket |
| 310: case | 320: housing |
| 323: slot | |

1. A detachable and detachable modular gripper for universal use, the gripper comprising:
a housing mounted with a gripping unit for gripping a work (work product); and
a front module attachable and detachable to the housing as a separate part, wherein the front module includes at least one of a robot server interface inputting a first signal to or outputting the first signal from an external device,
a driving module controller inputting a second signal or an electric power to, or outputting the second signal or the electric power from a driving module, and
a sensor interface part inputting or outputting a third signal of a sensor detecting an operation state of the gripping unit.

2. The gripper of claim 1, wherein the first signal is at least one of communication specifications of Ethernet, Ethercat, RS485, RS232 and CAN, and changeable depending on the kinds of external devices on the robot server interface, and wherein
a digital IO (Input Output) or an analog IO to be inputted to the driving module controller is generated by changing the first signal instructed from the external device according to any one of the communication specifications.

3. The gripper of claim 1, wherein the sensor interface part inputs a digital signal from the external device and outputs the digital signal to the external device by being disposed with an AD/DA converter.

4. The gripper of claim 1, wherein a first electric contact part provided at a partial area of a case surrounding the front module contacts a second electric contact part provided at a partial area of the housing, and when the first electric contact part and the second electric contact part are contacted to each other, at least one of the first signal, the electric power, the second signal and the third signal is transmitted to between the front module and the gripping unit.

5. The gripper of claim 4, wherein each of the first electric contact part and the second electric contact part takes a plate shape,
any one of the first electric contact part and the second electric contact part is provided with a plurality of spring fins capable of being changed in length to a direction perpendicular to the first electric contact part and the second electric contact part,
a remaining one of the first electric contact part and the second electric contact part is provided at a position opposite to each of the spring fins with a plurality of conductive plate,
each of the conductive plate is insulated, and
the conductive plate is an electrically conductive metal plate contacted by the spring fins, and contacted with the spring fin on a one-on-one base.

6. The gripper of claim 1, wherein the front module includes a first front module and a second front module, and any one of the first and second front modules is selectively attached to or detached from the gripping unit in response to signal patterns of the first signal, the second signal and the third signal.

7. The gripper of claim 1, further comprising a case surrounding the front module, wherein the case or the housing is provided at an inside or an outside thereof with a radiation fin, and wherein the radiation fin is provided in the form of a metal plate corrugated to the case or the housing.

8. A detachable and detachable modular gripper for universal use, the gripper comprising:
a gripping unit;
a housing mounted with a gripping unit, wherein
the gripping unit includes a gripping module gripping a work (work product), and a driving module providing a driving force to the gripping module, and one of the gripping module and the driving module is attachably and detachably provided on the housing.

9. The gripper of claim 8, wherein the jaw module or the housing is provided with a camera sensor, and the camera sensor detects a shape or a size of the work.

10. The gripper of claim 8, wherein the driving module includes a motor part and a power transmission part transmitting a turning force of the motor part as a driving power of the jaw module, wherein the motor part is attachably and detachably mounted to and from a first bracket tightly coupled to an inside of the housing, and the power transmission part is attachably and detachably mounted to and from a second bracket tightly coupled to an inside of the housing, and the first and second brackets are mutually connected, and attachable to and detachable from the housing.

11. The gripper of claim 8, wherein the driving module includes a motor part and a power transmission part transmitting a turning effect (force) of the motor part as a driving power of the jaw module, and a cross part is provided to connect a rotation shaft of the motor part to a main shaft of the power transmission part, wherein
the cross part transmits a turning force obtained from the rotation shaft to the main shaft, and when the motor part is separated from the driving module or the power transmission part is separated from the driving module, a connection state between the rotation shaft of the motor part and the main shaft of the power transmission part is released by the cross part.

12. The gripper of claim 8, wherein the jaw module is provided in a pair of mutually independent parts, and mounted on a bridge member connected to the driving module, one side of the bridge member is connected to the driving module, and the other side of the bridge member is attachable to and detachable from the jaw module, and a middle section of the bridge member is movably inserted into a slot provided at the housing.

13. The gripper of claim 8, further comprising a front module attachable to and detachable from the housing as a separate part to receive an electric signal from the gripping unit and to transmit the electric signal to the gripping unit, the front module, the driving module and the jaw module are provided in a plural number depending on selected information, the front module, the driving module and the jaw module specifically selected by the selected information are mutually assembled, and the selected information includes at least one of size, mass, strength and shape of the object.

14. The gripper of claim 13, wherein, when intrinsic codes mutually distinguishable by each object depending on the selected information, the front module, the driving module and the jaw module are mutually assembled by correspondence to the intrinsic code being selected.

15. The gripper of claim 8, wherein the object is fixed to the jaw module using an attaching means provided at the jaw module, the attaching means is attached or absorbed to the work when contacting the work, and the attaching means is a chemical adhesive or a suction device forming a negative pressure.

16. The gripper of claim 8, wherein the jaw module includes a jaw means directly contacting the work which is a grip object, the jaw means performs a linear movement or a rotary movement by the driving force of the driving module, and the work is gripped by a relative distance between jaw means being adjusted by the driving module.

17. The gripper of claim 8, wherein the jaw module is provided in a pair of mutually independent parts, and attachable to and detachable from the bridge member connected to the driving module, the driving module includes a main shaft receiving a driving force from the motor part accommodated in the housing, a driven shaft opposite to the main shaft and a timing belt connecting the main shaft and the driven shaft, wherein a linear movement of the timing belt is transmitted to the bridge member, one side of the bridge member is connected to the timing belt, and the other side of the bridge member is attachably and detachably connected to the jaw module, and a middle section between the one side of the bridge member and the other side of the bridge member is movably inserted into a slot provided at the housing.
